(19) United States
(12) Patent Application Publication
(10) Pub. No.: US 2025/0149014 A1
(43) Pub. Date: May 8, 2025

(54) DAMPENING SYSTEM FOR KEYBOARD PERCUSSION INSTRUMENTS

(71) Applicant: Eastman Percussion Instruments, LLC, Pomona, CA (US)

(72) Inventor: Leigh Howard Stevens, Shark River Hills, NJ (US)

(73) Assignee: Eastman Percussion Instruments, LLC, Pomona, CA (US)

(21) Appl. No.: 18/941,612

(22) Filed: Nov. 8, 2024

Related U.S. Application Data
(60) Provisional application No. 63/597,239, filed on Nov. 8, 2023.

(51) Int. Cl. G10H 1/32; G10D 13/08; G10H 3/20

(52) U.S. Cl. CPC G10H 1/32; G10D 13/08; G10H 3/20

(57) ABSTRACT

Described is a dampening system for keyboard percussion instruments. The dampening system includes two spring towers and a damper T bar with an extended vertical member connected with the two spring towers to assure rigid vertical motion between the two spring towers. To assist and maintain rigid directional control, the spring towers include integrated low friction guides. Further, a centrally located “strap re-direct” set of low friction ball bearing rollers to assure that the angle of the strap connected to a pedal can be adjusted for an absolutely perfect vertical pull down on the “T” bar.

### PRIORITY CLAIM

The present application is a Non-Provisional Utility Patent Application of U.S. Provisional Application No. 63,597,239, filed on Nov. 8, 2023, entitled, “Dampening System for Keyboard Percussion Instrument,” the entirety of which is incorporated herein by reference.

### BACKGROUND OF THE INVENTION

### (1) Field of Invention

The present invention relates to musical instruments and, more particularly, to a dampening system for keyboard percussion instruments.

### (2) Description of Related Art

Musical instruments implementing a dampening mechanism have long been known in the art. The tone-bar dampening system of a keyboard percussion instrument (such as a vibraphone) has always relied on “pivot arms,” beginning with the very first vibraphone in the early part of the 1900s. To this day, a damper pad made of wool felt, synthetic felt, or other suitable material is mounted on a stiff horizontal bar. The bar containing the pad pivots through an arc, controlled by “pivot arms” which are attached to the frame of the instrument. Any of the numerous vibraphone-centric patents will show this universally accepted arrangement.

A single, centrally-located compression spring is mounted in the middle of the instrument to provide upward pressure to the damper bar (the solid member covered in a flexible pad) against the tone-bars. Some form of connecting rod or strap is attached to a pedal, which pulls down on the damper bar against the spring, resulting in the damper being removed from contact with the tone bars. Upon release of the pedal, the spring re-applies upward pressure on the ends of the tone bar, dampening/shortening their free ring time.

Variations of this basic design are used by all of the current keyboard percussion instrument manufacturers throughout the world. While the market for this type of musical instruments is miniscule compared with guitars, pianos and other more common instruments, there are still more than twenty manufactures of this type of product, and competition is fierce.

The arm actuated damper guidance system is “ubiquitous” because it is simple and inexpensive. However, it is also “notorious” among musicians because its mode of operation (pivoting on an arch), dampens either the sharps, or the natural set of bars prior to the other. If the control arms are mounted on the player/natural side of the instrument, the natural keys are dampened prior to the sharps. If the control arms are mounted on the audience/sharps side of the instrument, the damper pad touches and dampens the sharps before the naturals.

In 2009, an inventor of the present disclosure applied for and was granted patent protection for a new device that allowed the player to compensate for those inherently musically “incorrect” angles. That application also had provision for a new concave shape for the damper pad that would damper the tone-bars in a more controllable, musically modulated way. Using that system, the damper pad initially touches the tone-bar close to the lower amplitude section and then swells into the more active anti-node end of the bar. The combination of those two mechanical features have become the world-wide standard for vibraphone damping finesse for professional players.

The last challenge to a more perfect dampening experience for the musician would be to eliminate the arc of the control arms. While a vertical motion of the damper bar and damper pad would be superior, in that the pad would contact both natural and sharp keys at the same moment, nothing heretofore has been devised in such a configuration. Notably, the more than twenty manufacturers of this product world-wide have never even shown a prototype of a vertical dampening system. The challenges to design and build a mechanism that is reasonable in cost and operates without “hanging up,” jamming, or listing side to side are numerous.

Thus, a continuing need exists for a new and improved dampening system for keyboard percussion instruments.

### SUMMARY OF INVENTION

The present invention relates to musical instruments and, more particularly, to a dampening system for keyboard percussion instruments. The dampening system includes two spring towers and a damper T bar with an extended vertical member connected with the two spring towers to assure rigid vertical motion between the two spring towers. To assist and maintain rigid directional control, the spring towers include integrated low friction guides. Further, a centrally located “strap re-direct” set of low friction ball bearing rollers to assure that the angle of the strap connected to a pedal can be adjusted for an absolutely perfect vertical pull down on the “T” bar.

Finally, as can be appreciated by one in the art, the present invention also comprises a method for forming and using the invention as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a dampening system in accordance with various embodiments of the present invention; and

FIG. 2 is a close-up view illustration of the dampening system in accordance with various embodiments of the present invention.

### DETAILED DESCRIPTION

The present invention relates to musical instruments and, more particularly, to a dampening system for keyboard percussion instruments. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

The present disclosure is directed to a dampening system for a keyboard percussion instruments, as well as such percussion instruments having the dampening system incorporated therein. As noted above, tone-bar dampening systems of keyboard percussion instruments (such as a vibraphone) of the prior art have always relied on “pivot arm”. While somewhat functional, existing systems are unable to provide a perfect dampening experience for the musician as they are unable to eliminate the arc of the control arms. The inventors submit that vertical motion of the damper bar and damper pad would be superior, in that the pad would contact both natural and sharp keys at the same moment. However, the challenges to design and build a mechanism that is reasonable in cost and operates without “hanging up,” jamming, or listing side to side are numerous. After several years of research and experimentation, the invention of the present disclosure solves those technical challenges by disclosing an armless vertical keyboard percussion instrument dampening system.

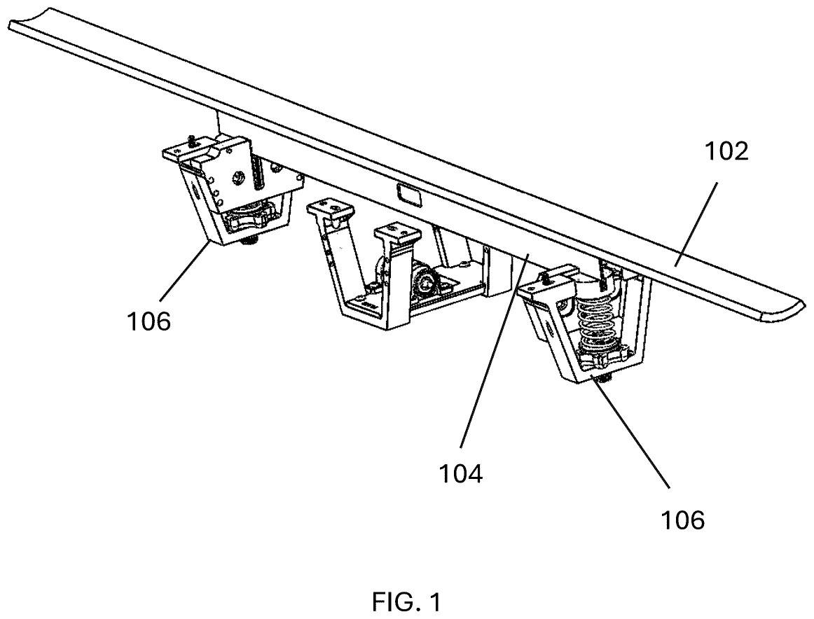

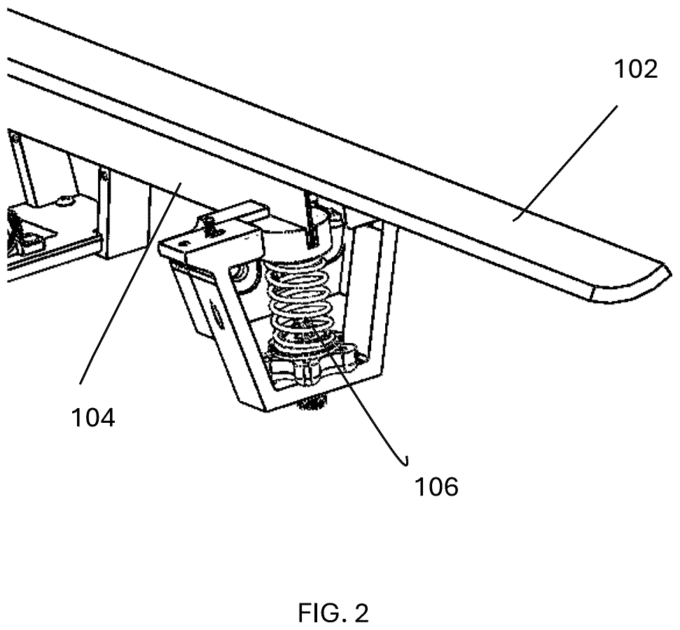

As shown in FIGS. 1 and 2, the present invention solves the issues of the prior art through use of double springs that pull vertically down on the damper bar, eliminating the pivot arms. The dampening system 100 of the present invention includes a damper “T” bar 102 that has an extended vertical member 104 to assure rigid vertical motion between two spring towers 106 that have integrated low friction guides. A centrally located “strap re-direct” set of low friction ball bearing rollers assures that the angle of the strap connected to the pedal can be adjusted for an absolutely perfect vertical pull down on the “T” bar. Dual springs 106 assure that the system can be adjusted to be parallel to the floor below the instrument, and parallel to the bottom surface of the tone-bars above. Dual springs 106 also allow the player to adjust the dampening effect of the upper and lower range of the instrument differently.

This new improved system is easily integrated with my previously patented concave damper pad (U.S. Pat. No. 8,049,089 (the '089 Patent)) and my leverage-adjustable patent that allows the player to change the connection point of the strap to the pedal (U.S. Pat. No. 8,525,009 (the '009 Patent)). Both the '089 and '009 Patents are incorporated by reference as though fully set forth herein.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A dampening system for keyboard percussion instruments, comprising:
two spring towers; and
a damper T bar with an extended vertical member connected with the two spring towers to assure rigid vertical motion between the two spring towers.

2. The dampening system as set forth in claim 1, wherein the spring towers include integrated low friction guides.

3. The dampening system as set forth in claim 2, further comprising a centrally located “strap re-direct” set of low friction ball bearing rollers to assure that the angle of the strap connected to a pedal can be adjusted for an absolutely perfect vertical pull down on the “T” bar.
